(19) United States
(12) Patent Application Publication
(10) Pub. No.: US 2025/0321469 A1
(43) Pub. Date: Oct. 16, 2025

(54) PHOTOGRAPHING AID AND PHOTOGRAPHING DEVICE

(71) Applicant: Shenzhen Leqi Innovation Co., Ltd., Shenzhen (CN)

(72) Inventors: Tao JIANG, Shenzhen (CN); Wei TANG, Shenzhen (CN)

(73) Assignee: Shenzhen Leqi Innovation Co., Ltd., Shenzhen (CN)

(21) Appl. No.: 19/021,208

(22) Filed: Jan. 15, 2025

(30) Foreign Application Priority Data
Apr. 15, 2024 (CN) 202420801863.8

(51) Int. Cl. G03B 17/56

(52) U.S. Cl. CPC G03B 17/561; G03B 17/563; G03B 17/566; G03B 2217/007

(57) ABSTRACT

A photographing aid includes an outer casing and an inner casing. The outer casing includes a cavity and an opening. The inner casing can be placed in or taken out of the cavity via the opening. The inner casing includes a data interface being electrically connected to a photographing device. The inner casing, in which a hard disc drive or a battery is installed, can be placed in the cavity to be carried easily; and the photographing device can be electrically connected to the data interface of the inner casing by a cable passing through the opening, such that the complex operation of taking and placing the inner casing is avoided, the data in the photographing device can be saved in the hard disc drive and the photographing device can be recharged by the battery, and the photographing experience of the users is improved.

### FIELD

The invention relates to the technical field of photographing equipment, in particular to a photographing aid and a photographing device.

### BACKGROUND

With the rapid development of network and multimedia, the use of mobile phones or tablet computers for photographing has become a current trend. When a mobile phone is used for photographing, aids are often used to make operation easier. For example, to prolong the photographing time, a battery is used to charge the mobile phone; to expand the storage capacity, the mobile phone often needs to be connected to an external hard disk or memory.

At present, external functional components are often used to expand the storage capacity or prolong the photographing time. For example, an external hard disk drive is used to expand the storage capacity; and an external battery is used to prolong the photographing time. Since the hard-disk cartridge or a power supply is an independent accessory, an extension device or other aids need to be added, leading to a large number of extra accessories and making carrying inconvenient. In addition, operation is also inconvenient, for example, when a mobile phone needs to be connected to a hard disk during photographing, a series of actions including taking out the hard disk. connecting a data line and the mobile phone and the like need to be performed, so contents recorded in the photographing device cannot be quickly transferred to the hard disk, and the photographing continuity is seriously affected, thus compromising photographing experience.

### SUMMARY

The main objective of the invention is to provide an improved photographing aid to solve the problem that a hard disk drive or a battery is inconvenient to carry.

In one aspect, the present invention provides a photographing aid comprising an outer casing comprising a cavity and an opening in communication with the cavity, the opening being formed in an end of the outer casing to communicate the cavity with outside the outer casing; an inner casing being detachably accommodated in the cavity via the opening, the inner casing comprising an interface configured to be electrically connected to a photographing device; and a locking structure being arranged between the outer casing and the inner casing for releasably locking the inner casing in the outer casing.

In some embodiments, the inner casing comprising at least one accommodation chamber; at least one electronic device is accommodated in the at least one accommodation chamber. The electronic device can be a hard disk drive configured for storing data transferred from the photographing device or a battery for charging the photographing device.

In some embodiments, a locking slot is formed in an inner surface of a wall of the body delimiting the cavity, and a locking member is arranged on the electronic device for being interlocked in the locking slot.

In some embodiments, the locking member comprises a press potion and a hook portion connected to the press portion, the press portion is elastically connected to the inner casing, and the hook portion is configured to be interlocked in the locking slot.

In some embodiments, the body defines a length direction and a height direction, the electronic device is mounted into the cavity in the length direction, and the press portion together with the hook portion is movable relative to the body in the height direction.

In some embodiments, the body further comprises a notch; and the locking member is received in the cavity and the press portion of the locking member extends through the notch to be exposed outside of the body.

In some embodiments, the body comprises a pair of side walls and a pair of connecting walls cooperatively delimiting the cavity; the connecting walls are located at opposite sides of the cavity in a width direction which is perpendicular to the length direction and the height direction; and the locking slot and the notch are defined in one of the side walls at interval.

In some embodiments, a guide strip is formed on an inner surface of each of the connecting walls.

In some embodiments, each of the connecting wall comprises a middle portion and a pair of opposite end portions located at opposite side of the middle portion in the height direction, the middle portion is convex outwardly relative to the opposite end portions, and the guide strip is formed at the middle portion.

In some embodiments, another one of the side walls is concaved inwardly in the height direction to form a recess at an outer surface thereof; and a connecting member is received in the recess and secured to the another one of the side walls.

In some embodiments, a mounting portion is arranged in a convex manner on a bottom of the recess; the connecting member comprises a pair of positioning ribs spaced apart from each other and a receiving channel is formed between the pair of positioning ribs; and the connecting member is secured on the mounting portion which is received in the receiving channel, and the positioning ribs are located at opposite sides of the mounting portion.

In some embodiments, a connecting component is arranged on an inner wall of the body, and the electronic device is detachably connected to the connecting component.

In some embodiments, the connecting component comprises a mounting shell and a clamping member; the mounting shell is connected to the inner wall of the body; the clamping member comprises a clamping end and a sliding end connected to the clamping end; a barb is arranged on the electronic device; the clamping end comprises at least two clamping arms for clamping the barb; and the sliding end is slidably arranged in the mounting shell.

In some embodiments, the sliding end is elastically connected to a bottom of the mounting shell; the connecting component further comprises a rocker arm; a guide groove is formed in the mounting shell; and the rocker arm comprises an end connected to the sliding end and an opposite end slidably connected to the guide groove.

In some embodiments, at least one guide strip is arranged on an inner wall of the body and slidably connected to the electronic device.

In some embodiments, a connecting member is arranged on the body and configured to be detachably connected to a handheld extension device on which the photographing device is fixed.

In some embodiments, the connecting member is strip-shaped and parallelly arranged on an outer surface of the body.

In some embodiments, the connecting member extends along a length direction of the body, and a plurality of anti-skip structures extending along a width direction of the body is arranged on the connecting member.

In another aspect, the present invention further provides a photographing device comprising a photographing device and a photographing aid described above, wherein the photographing aid is electrically connected to the photographing device by means of the data interface.

In some embodiments, a connecting member is arranged on the body, the photographing device is fixed to a handheld extension device, and the connecting member is detachably connected to the handheld extension device.

In some embodiments, the photographing device comprises a pair of the photographing aids; and the handheld extension device comprises a pair of clamps configured to detachably catch the connecting members arranged on the bodies of the photographing aids.

In some embodiments, the connecting members are strip-shaped and positions where the clamps catch the connecting members are adjustable.

The cavity and the opening are formed in the photographing aid, such that the inner casing, in which a battery and/or a hard disk drive is installed, can be placed into the cavity to be carried easily and conveniently. The photographing device can be electrically connected to the inner casing accommodated in the cavity by means of a cable passing through the opening, such that the complex operation of taking and placing the inner casing is avoided, data in the photographing device can be saved to the hard disk drive and/or the photographing device can be charged by the battery more easily, and the photographing experience of the users is improved.

### BRIEF DESCRIPTION OF THE DRAWINGS

FIG. 1A is a perspective view of an outer casing of a photographing aid according to an embodiment of the invention;

FIG. 1B is a perspective view of an inner casing of the photographing aid according to an embodiment of the invention;

FIG. 1C is an exploded view of the photographing aid according to an embodiment of the invention;

FIG. 2 is as assembled view of the photographing aid of FIG. 1C with electronic devices mounted in the inner casing;

FIG. 3 is a cross-sectional view of FIG. 2, taken along line A-A;

FIG. 4 is a perspective view of a connecting assembly of the inner casing of FIG. 2;

FIG. 5 is a perspective view of a photographing aid according to another embodiment of the invention;

FIG. 6 is a perspective view of a connecting component according to the invention;

FIG. 7 is a structural view of a clamping member according to the invention;

FIG. 8 is an internal structural view of the connecting component according to one embodiment of the invention;

FIG. 9 illustrates an inner casing and the connecting component according to one embodiment of the invention;

FIG. 10 is a connection diagram of the photographing aid and a handheld extension device according to the invention;

FIG. 11 is a partial structural view of another embodiment of the photographing aid according to the invention;

FIG. 12 is a structural view of a first connecting component according to the invention; and

FIG. 13 is a perspective view of a photographing device according to one embodiment of the invention.

### REFERENCE SIGNS

100, inner casing; 110, cavity; 111, opening; 120, first connecting component; 130, recess; 131, mounting portion; 140, slot; 150, connecting component; 151, mounting shell; 1511, guide groove; 152, clamping member; 1521, clamping end; 1521a, clamping arm; 1522, sliding end; 153, rocker arm; 160, guide strip; 200, inner casing; 210, locking member; 211, press portion; 212, hook portion; 220, data interface; 300, photographing device; 400, handheld extension device.

### DESCRIPTION OF THE EMBODIMENTS

The technical solutions in the embodiments of the invention will be clearly and completely described below in conjunction with accompanying drawings of these embodiments. Obviously, the embodiments in the following description are merely illustrative ones and are not all possible ones of the invention. All other embodiments obtained by those ordinarily skilled in the art according to the following ones without creative labor should also fall within the protection scope of the invention.

It should be noted that all directional indications (such as “upper”, “lower”, “left”, “right”, “front” and “back”) in the embodiments of the invention are merely used to explain relative positional relations and motions between components in a specific attitude (as shown below), and once the specific attitude changes, these directional indications will change accordingly.

It should also be noted that when one element is referred to as being “fixed to” or “arranged on” the other element, it may be “fixed to” or “arranged on” the other element directly or by means of an intermediate element. When one element is referred to as being “connect to” the other element, it may be connected to the other element directly or by means of an intermediate element.

In addition, descriptions such as “first” and “second” involved in the invention are merely for a purpose of description, and should not be construed as indicating or implying relative importance or implicitly indicating the number of technical features referred to. Therefore, a feature defined by “first” or “second” may explicitly or implicitly indicate the inclusion of at least one said feature. In addition, the technical solutions in the embodiments may be combined as long as it can be implemented by those skilled in the art. In a case where a combination of the technical solutions is contradictory or cannot be implemented, the combination should be construed as non-existent and will not fall within the protection scope of the invention.

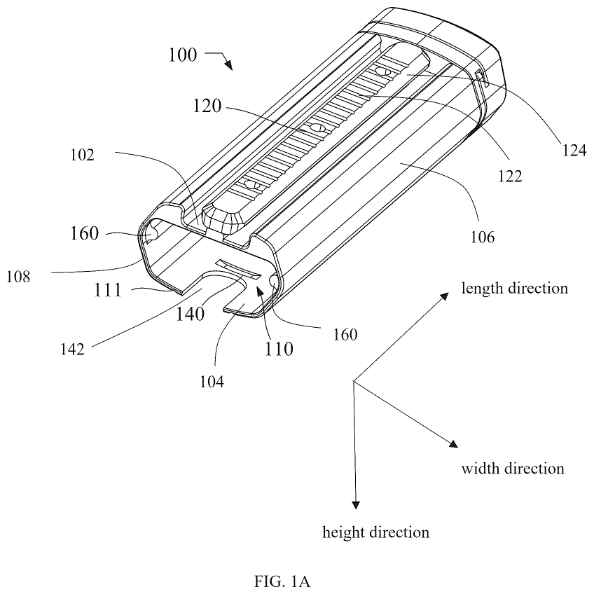

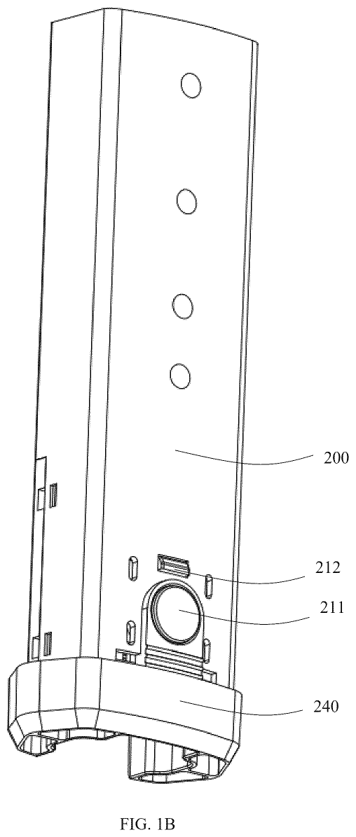

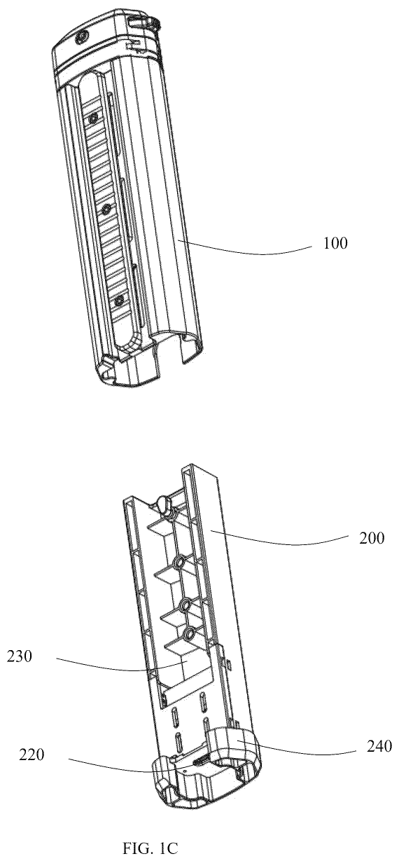

The invention provides a photographing aid. Referring to FIGS. 1 and 12, the photographing aid comprises an outer casing 100, an inner casing 200, and a locking structure arranged between the outer casing 100 and the inner casing 200 for releasably locking the inner casing 200 in the outer casing 100.

The outer casing 100 comprises a cavity 110 for receiving the inner casing 200 and an opening 111 formed at an end of the outer casing 100 and connected to the cavity 110.

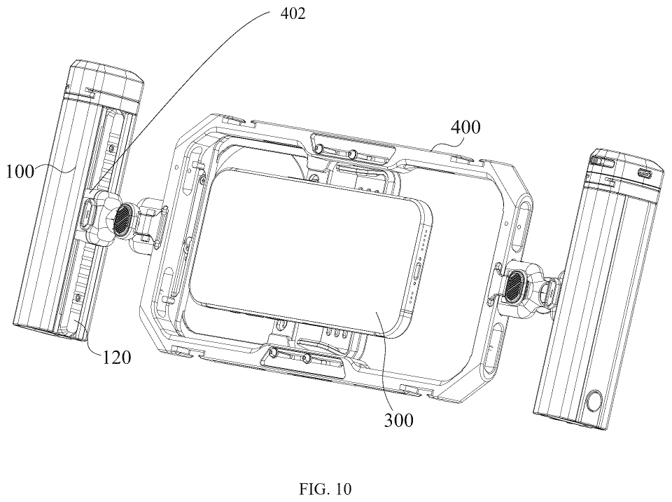

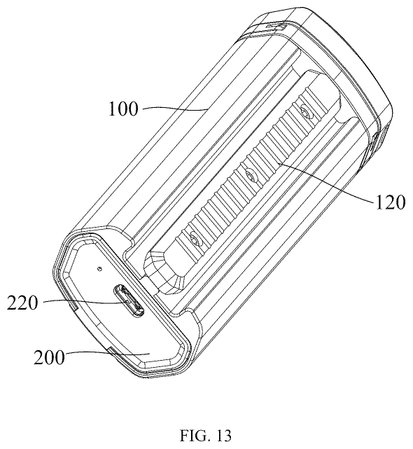

The inner casing 200 is placed in or taken out of the cavity 110 via the opening 111, the inner casing 200 is provided with a data interface 220 (see FIG. 13), and the data interface 220 may be electrically connected to a photographing device 300 (see FIG. 10) by means of a cable passing through the opening 111. The inner casing 200 comprises at least one accommodation chamber 230. At least one electronic device 240 can be accommodated in the at least one accommodation chamber. The electronic device 240 can be a hard disk drive configured for storing data transferred from the photographing device 300 or a battery for charging the photographing device 300.

The photographing aid, as a device for improving photographing convenience, may be a support device such as a tripod, a selfie stick, a photographing stand or a light tripod; a lighting device such as a flashlight, a reflector or a snoot; or, a speaker, a remote controller or a tripod head. It can be understood that any devices, in which the cavity 110 for receiving the inner casing 200 is formed, should fall within the protection scope of the invention.

The cavity 110 in the outer casing 100 is configured for receiving the inner casing 200, and the shape and size of the cavity 100 may be determined as needed, for example, in a case where the inner casing 200 is columnar, the cavity 100 may be columnar to match the inner casing 200. It can be understood that the size of the cavity 110 may be greater than that of a single inner casing 200, such that multiple inner casings 200 and/or batteries may be stored in the cavity 110.

The opening 111 connected to the cavity 110 is formed in the outer casing 100, such that the inner casing 200 installed in the cavity 110 can be connected to the photographing device 300. For example, if the inner casing 200 is provided with the data interface 220, the data interface 220 of the inner casing 200 is exposed outside the outer casing 100 via the opening 111. The data interface 220 and the photographing device 300 can be electrically connected by means of a data cable to thereby achieve the function of transferring photographing data from the photographing device 300 to the hard disk drive installed in the inner casing 200 or charging the photographing device 300 by the battery installed in the inner casing 200. If multiple inner casings 200 are accommodated in the cavity 110, a large opening 111 may be formed in the outer casing 100 or multiple openings 111 corresponding to the data interfaces 110 respectively may be formed in the outer casing 100 to ensure that the photographing device 300 can be connected to each of the data interfaces 220.

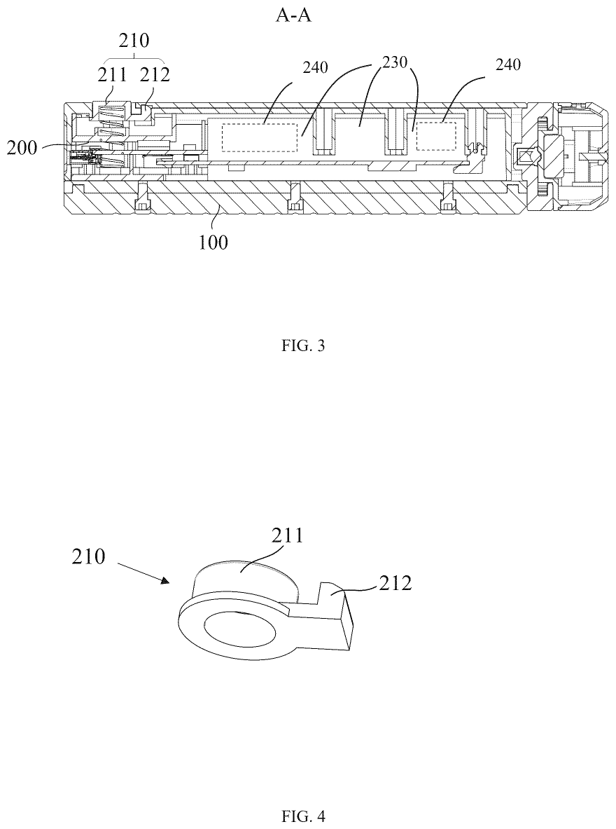

As shown in FIGS. 1A-3, in some embodiments, the locking structure comprises a locking slot 140 formed in an inner surface of a wall of the outer casing 100, and a locking member 210 arranged on the inner casing 200. The locking member 210 arranged on the inner casing 200 can be engaged in the locking slot 140.

The locking member 210 can be engaged in the locking slot 140 to secure the inner casing 200 in the outer casing 100. Wherein, the locking member 210 may be a simple protruding structure, or a link structure formed by multiple parts as long as it can cooperate with the locking slot 140 to fix the inner casing 200 in the cavity 110. By the locking member 210 being engaged in the locking slot 140, the inner casing 200 can be mounted more easily and conveniently.

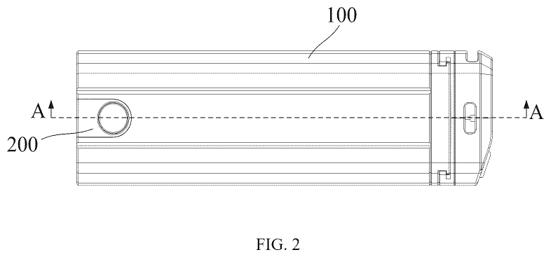

As shown in FIGS. 2-4, in some embodiments, the locking member 210 comprises a press portion 211 and a hook portion 212 connected to the press portion 211, wherein the press portion 211 is elastically connected to the inner casing 200, and the hook portion 212 may be interlocked in the locking slot 140.

The locking member 210 comprises the press portion 211 and the hook portion 212 connected to the press portion 211, wherein the press portion 211 is connected to the inner casing 200 by means of a spring, such that the locking member 210 can move upwards/outwardly and downwards/inwardly. The position of the locking member 210 is arranged such that the hook portion 212 is exactly hooked in the locking slot 140 when the inner casing 200 is received in the cavity 110 of the outer casing 100, whereby the position of the electronic device with respect to the photographing aid being fixed. When the inner casing 200 needs to be taken out, the press portion 211 is pressed inwardly to drive the hook portion 212 to move and disengage from the locking slot 140, and at this moment, the inner casing 200 can be taken out from the opening 111 of the cavity 100. Further, a U-notch 142 is formed at the opening 111 of the cavity 110, such that the press portion 211 can be exposed out of an outer surface of the outer casing 100 via the U-notch 142 to be pressed by users; and the press portion 211 can slide in or out in a length direction of the outer casing 100 via the U-notch 142 to fulfil a guiding effect, such that users can accurately mount the inner casing 200 in the outer casing 100.

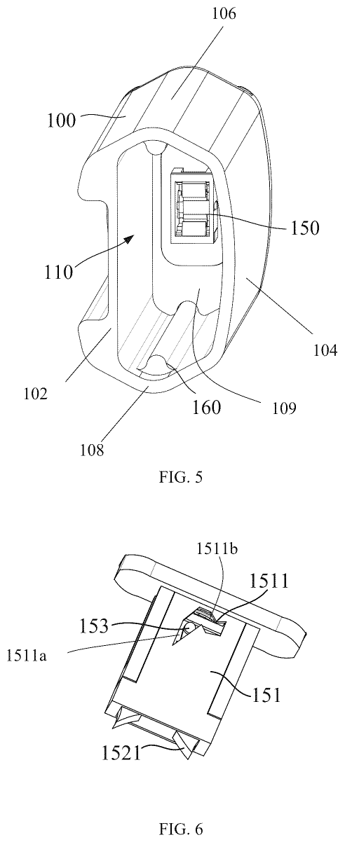

As shown in FIG. 5, in some embodiments, a connecting component 150 is arranged on the end wall 109 of the outer casing 100, and the inner casing 200 is detachably connected to the connecting component 150. The connecting component 150 may be connected to the inner casing 200 in various ways according to specific cases and design requirements.

First, the connecting component 150 is a magnetic element, a component that can be attracted by the magnetic element is arranged at a position, corresponding to the magnetic element, of the inner casing 200, and the inner casing 200 can be fixed by means of the attractive force of the magnetic element.

Second, the connecting component 150 is threadedly connected to the inner casing 200, the inner casing 200 can be rotated to be fixed in the outer casing 100.

Third, similar to the connection between a plug and a socket, the connecting component 150 is a plug, a specific insertion slot or connecting port is correspondingly formed in the inner casing 200, and the plug is inserted into the insertion slot to fix the inner casing 200 in the outer casing 100.

By using the connecting component 150 to fix the inner casing 200 in the outer casing 100, the hard disk drive or the battery can be stored in the inner casing 200 conveniently, thus improving the usage experience of users.

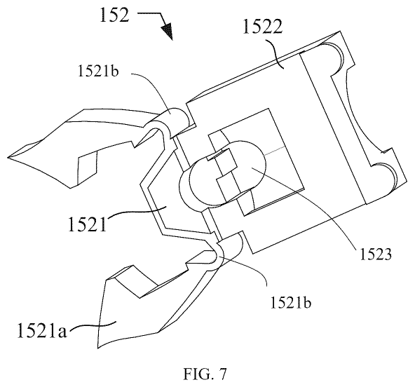

As shown in FIGS. 6-7 and 9, in some embodiments, the connecting component 150 comprises a mounting shell 151 and a clamping member 152, wherein the mounting shell 151 is connected to the end wall 109 of the outer casing 100, the clamping member 152 comprises a clamping end 1521 and a sliding end 1522 connected to the clamping end 1521. One end of the inner casing 200 defines an opening 202 in which a barb 204 is arranged. The other end of the inner casing 200 comprises a handle 206. When the inner casing 200 is mounted in the outer casing 200, the handle 206 is exposed outside the casing 200 for facilitating operating. The connecting component 150 and the barb 204 cooperatively form a locking structure for locking the inner casing 200 in the outer casing 100. The clamping end 1521 comprises at least two clamping arms 1521a for clamping the inner casing 200, and the sliding end 1522 is slidably arranged in the mounting shell 151.

The barb 204 that can be clamped by the clamping end 1521 is arranged in the inner casing 200, and the clamping end 1521 of the clamping member 152 is generally made from an elastic material. In this embodiment, the clamping end 1521 has a substantial M shape and comprises two clamping arms 1521a, which are arranged oppositely and extend away from each other, and the two clamping arms 1521a clamps the barb when the two clamping arms 1521a moves toward each other. More clamping arms 1521a may be arranged, and this embodiment has no limitation in this aspect.

Specifically, the inner casing 200, when used, is pushed into the outer casing 100, at this moment, the barb 204 is inserted into a space formed between the two clamping arms 1521a to abut against the middle portion of the clamping end 1521 to thereby push the whole clamping member 152 to move inwards. As being limited by the sidewalls of the mounting shell 151, the two clamping arms 1521a are squeezed to move toward each other and gradually retract inwards to firmly clamp/catch the barb 204, such that the inner casing 200 is fixed in the outer casing 100. When the inner casing 200 needs to be taken out, the inner casing 200 is pulled outwards by operating the handle 206. Since the barb 204 of the inner casing 200 is clamped by the clamping end 1521, the inner casing 200 drives the whole clamping member 152 to move outwards. When the clamping arms 1521a are moved out of and no longer be limited by the mounting shell 151 after the clamping member 152 moves outwards by a certain distance, the clamping arms 1521a will move away from each other to return to their original state to thereby release the barb 204 of the inner casing 200, and the inner casing 200 can be easily taken out by users. Preferably, each clamping arm 1521a comprises a bent portion 1521b formed at a joint between the clamping arm 1521a and the middle portion of the clamping end 1521. The bent portion 1521b facilitates the clamping arm 1521a to bend inwardly or outwardly. Each clamping arm 1521a further comprises a barb formed at a free end thereof.

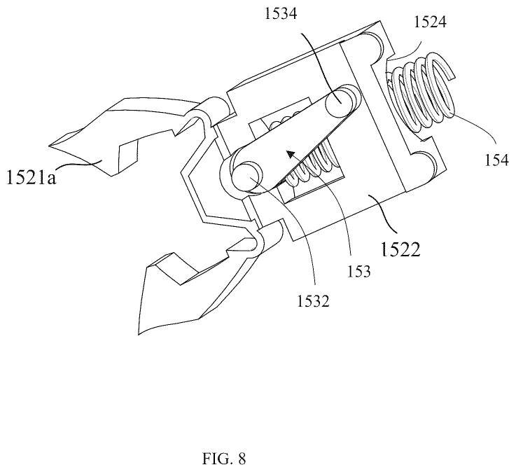

As shown in FIGS. 6-8, in some embodiments, the sliding end 1522 is elastically connected to the bottom of the mounting shell 151, the connecting component 150 further comprises a rocker arm 153, a guide groove 1511 is formed in the mounting shell 151, one end 1532 of the rocker arm 153 is connected to the sliding end 1522, and the other end 1534 of the rocker arm 153 is a free end which can swing about the connecting end 1532. The free end 1534 is slidably connected to the guide groove 1511.

In this embodiment, a spring 154 is arranged between the sliding end 1522 and the bottom of the mounting shell 151 to realize elastic connection between the sliding end 1522 and the bottom of the mounting shell 151. Preferably, a guide structure, such as a guide pillar 1523 or a recess 1524, may be arranged at the sliding end 1522, and one end of the spring 154 is disposed around the guide pillar 1523 or received in the recess 1524, such that the spring 154 is prevented from deflection in the compression or stretching process, and the service life of the spring is prolonged.

The guide groove 1511 is divided into two segments, wherein a first segment 1511b extends in a direction from outside to inside (i.e., the direction from the opening of the mounting shell 151 toward the bottom of the mounting shell 151), a second segment 1511b extends from inside to outside, and the distance between a farthest end of the second segment and the bottom of the mounting shell 151 is less than the distance between the farthest end of the first segment and the bottom of the mounting shell 151, such that the clamping member 152 can be stopped at two different positions in the sliding process. Specifically, with the inner casing 200 as an example, in an initial state, the free end 1534 of the rocker arm 153 is received in the first segment 1511a of the guide groove 1511, and at this moment, the clamping arms 1521a and the spring are both in a relaxed state; when the inner casing 200 is pushed into the outer casing 100, the barb on the inner casing 200 presses the clamping member 152 to move inwards, the spring 154 is compressed and deformed, the rocker arm 153 moves inwards synchronously, the free end 1534 of the rocker arm 153 moves from the first segment 1511a to the second segment 1511b. After the inner casing 200 is released and the free end 1534 of the rocker arm 153 is maintained at the second segment 1511b under the action of the spring 154, at this moment, the clamping arms 1521a and the spring 154 are both in a tensioned state, and the inner casing 200 is fixed in the outer casing 100. When the inner casing 200 needs to be taken out, the inner casing 200 connected with the clamping member 152 is pulled outwardly, the free end 1534 of the rocker arm 153 moves from the second segment 1511b to the first segment 1511a of the guide groove 1511, and the spring 154 returns toward its original state and push the clamping member 152 outward. After the clamping arms 1521a are moved out of the mounting shell 151, the clamping arms 1521a release the barb, and users can take out the inner casing 200 easily. By means of the spring 154, the rocker arm 153 and the guide groove 1511, the inner casing 200 can be placed in and taken out of the outer casing 100 more easily and can be connected to the outer casing 100 more firmly, and the problem that the inner casing 200 slides out of the outer casing 100 under the action of gravity is avoided.

As shown in FIG. 1, in some embodiments, at least one guide strip 160 is arranged on the inner wall of the outer casing 100 and slidably connected to the inner casing 200. By means of the guide strip 160, the inner casing 200 can be mounted at the right position, the barb on the inner casing 200 can be accurately clamped by the clamping member 152, and damage to the connecting component 150 caused by installation of the inner casing 200 at an incorrect position is avoided.

Referring to FIGS. 1 and 5, the outer casing 100 preferably has a substantial rectangular cross-section and comprises a pair of side walls 102, 104 and a pair of connecting walls 106, 108 connected between opposite ends of the side walls 102, 104 respectively. The side walls 102, 104 are substantially parallel to each other. The locking slot 140 and the U-shaped notch 142 are formed in the side wall 104 at interval. Each of the connecting walls 106, 108 is convexed outwardly from a middle thereof. A pair of guide strips 160 extending along the length direction of the outer casing 100 is arranged on inner surfaces of the connecting walls 106, 108 of the outer casing 100 respectively. The pair of guide strips 160 are located at opposite sides of the cavity 110 in the width direction and parallel to each other.

As shown in FIGS. 10-12, in some embodiments, a connecting member 120 is arranged on the outer casing 100, the photographing device 300 may be fixed to a handheld extension device 400, and the connecting member 120 can be detachably connected to the handheld extension device 400.

The photographing device 300 may be different types of cameras or mobile phones. For the sake of portability, the photographing device 300 generally has a photographing function and cannot be directly connected to the photographing aid, and the photographing angle and height cannot be adjusted freely, so the photographing device 300 is generally fixed to the handheld extension device 400. For example, as shown in FIG. 2, the photographing device 300 is a mobile phone which is mounted on the handheld extension device 400 to be controlled more easily to complete photographing. In view of this, in this embodiment, the connecting member 120 is arranged on the outer casing 100, and the photographing aid can be detachably connected to the handheld extension device 400 by means of the connecting member 120, such that users can use the photographing aid more easily and can store the inner casing 200 in the cavity 110 of the outer casing 100 more easily, and the portability of the photographing aid is further improved.

The connecting member 120 may be connected to the handheld extension device 400 in various ways. Specifically, the connection ways comprise the following:

First, the connecting member 120 is threadedly connected to the handheld extension device 400.

In this embodiment, the connecting member 120 is a threaded rod provided with an external thread, the handheld extension device 400 is a threaded hole matched with the threaded rod, and the connecting member 120 is detachably connected to the handheld extension device 400 by means of the threaded rod and the threaded hole. It can be understood that the threaded rod may be arranged on the handheld extension device 400, and the corresponding threaded hole may be formed in the connecting member 120.

Second, the connecting member 120 is connected to the handheld extension device 400 by snap fit.

In this embodiment, the connecting member 120 is a protrusion arranged on the outer surface of the outer casing 100, a groove matched with the protrusion is correspondingly formed in the handheld extension device 400, and the protrusion can be snap-fitted in the groove to fix the photographing aid to the handheld extension device 400. Specifically, the shape of the protrusion may be set as needed, for example, the protrusion may be mushroom-shaped, the diameter of an opening of the groove is controlled to be slightly less than the maximum diameter of the protrusion, and in use, the protrusion can be pressed into the groove.

The connecting member 120 may be hinged to the handheld extension device 400 or connected to the handheld extension device 400 by means of pins or common connecting structures on the market, which will not be repeated here. Wherein, the connecting member 120 and the outer casing 100 may be formed integrally, or the connecting member 120 may be arranged on the outer casing 100 by bonding, welding, or the like. This embodiment has no limitation in this aspect.

In this embodiment, the cavity 110 and the opening 111 in communication with the cavity 110 are formed in the photographing aid, such that the inner casing 200 can be accommodated in the cavity 110. Thus, the inner casing 200 can be carried more easily and conveniently. Further, the users can connect the photographing device 300 to the inner casing 200 accommodated in the cavity 110 by means of the opening 111 in the photographing aid, such that the complex operation of taking and placing the inner casing 200 is avoided, the users can save data in the photographing device 300 and charge the photographing device 300 more easily, and the photographing experience of users is improved; moreover, the connecting member 120 is arranged on the outer casing 100, such that the photographing aid can be directly fixed to the handheld extension device 400, thus further improving the portability of the photographing aid.

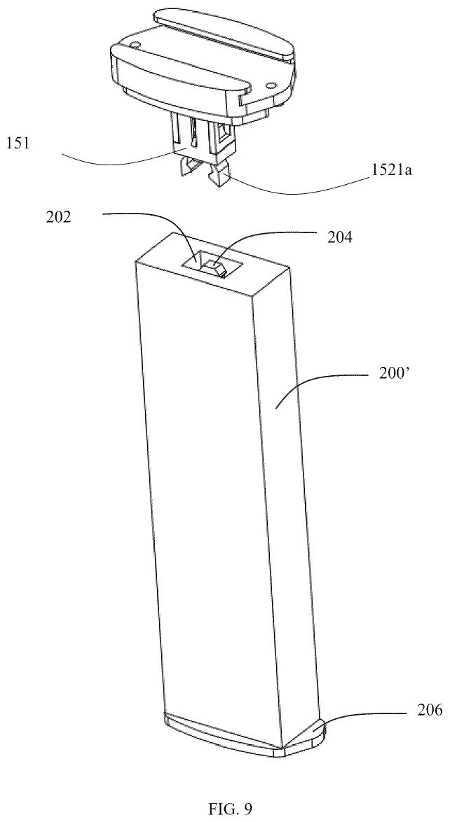

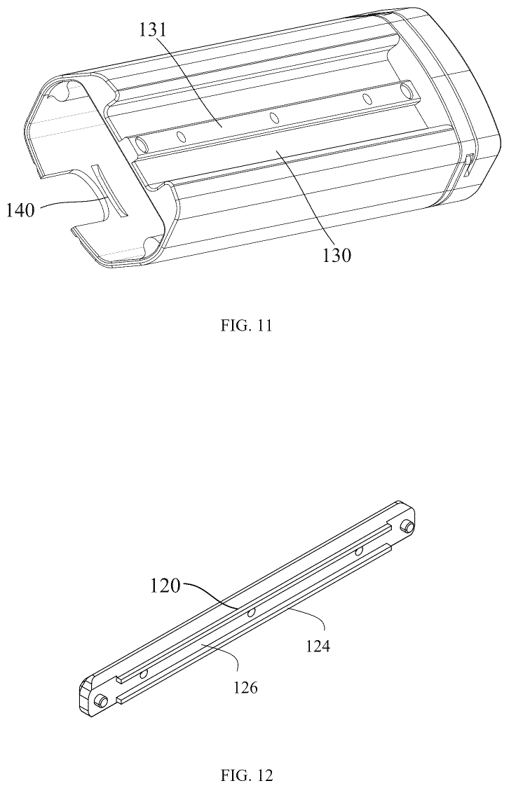

As shown in FIGS. 1 and 11, in some embodiments, the connecting member 120 is strip-shaped and parallelly arranged on the outer surface of the outer casing 100. In this embodiment, the side wall 102 of the outer casing 100 is concaved inwardly at a middle thereof to thereby form a recess 130 (see FIG. 10) at the outer surface thereof. The connecting member 120 is received in the recess of the side wall 102 of the outer casing 100. A clamp 402 (see FIG. 9) is arranged on the handheld extension device 400, wherein the clamp 402 may be a clip or other common clamping assemblies. By means of the clamp 402 catching the connecting member 120, the photographing aid can be fixed to the handheld extension device 400. Because the connecting member 120 is strip-shaped, the clamp 402 on the handheld extension device 400 can be clamped in different positions of the connecting member 120, that is, the position of the photographing aid with respect to the handheld extension device 400 can be adjusted as needed, and the photographing aid can be arranged more flexibly. In this embodiment, the strip-shaped connecting member 120 extends along the length direction of the outer casing 100. A plurality of anti-skip structures 122 such as anti-ship grooves is arranged on the surface of the connecting member 120 opposite to the side wall 102 of the outer casing 100. The anti-skip structures 122 extend along the width direction of the outer casing 100. The anti-skip structures 122 facilitate to maintain the position of the clamp 402 relative to the connecting member 120 and prevent the clamp 402 from moving randomly relative to the connecting member 120. As shown in FIG. 10, a mounting portion 131 is arranged in a convex manner on the bottom of the recess 130 of the side wall 102 of the outer casing 100. A plurality mounting holes are defined in the mounting portion 131. The connecting member 120 comprises a pair of positioning ribs 124 spaced apart from each other. A receiving channel 126 is formed between the pair of positioning ribs 124. The connecting member 120 is mounted on the mounting portion 131 with the mounting portion 131 being received in the receiving channel 126 and the pair of positioning ribs 124 being disposed at opposite sides of the mounting portion 131. The connecting member 120 defines a plurality of through holes corresponding to the mounting holes of the mounting portion 131. The through holes are preferably located between the positioning ribs 124. The connecting member 120 can be fixed to the mounting portion 131 by fasteners which extend through the through holes of the first connecting components 120 to be engaged in the mounting holes of the mounting portion 131.

It should be noted that the connecting member 120 does not need to be entirely arranged on the outer casing 100. For example, if the outer casing 100 is a columnar handle, the connecting member 120 may be arranged in a length direction of the outer casing 100, and the bottom of the connecting member 120 in a depth direction of the connecting member 120 is connected to the outer casing 100. The connecting member 120 may also be arranged in a direction perpendicular to the length direction of the outer casing 100, and in this case, only part of the bottom of the connecting member 120 is directly connected to the outer casing 100. The connecting member 120 may also be arranged in other directions. The specific arrangement of the connecting member 120 may be selected as needed, and this embodiment has no limitation in this aspect. In use, first, the clamp 402 of the handheld extension device 400 is opened, the connecting member 120 is moved to a position where it can be clamped by the clamp 402, and then, the clamp 402 is closed to catch the connecting member 120 to thereby connect the photographing aid and the handheld extension device 400. If the clamping position needs to be changed, the clamp 402 can be opened, and then the connecting member 120 is moved relative to the clamp 402; or, the connecting member 120 can be directly slid in the clamped state to adjust the position of the photographing aid.

Further, at least one slope 124 is arranged on each of two sides of the connecting member 120 and extends from bottom to top to allow the clamp 402 of the handheld extension device 400 to be clamped thereon to enlarge the contact area, such that the photographing aid is firmly fixed to the handheld extension device 400.

As shown in FIGS. 9 and 12, the invention further provides a photographing device which comprises a photographing device 300 and a photographing aid. The specific structure of the photographing aid can be understood with reference to the above embodiments. Because the photographing device adopts all the technical solutions of the above embodiments, it at least has all the technical effects fulfilled by the above embodiments, which will not be repeated here. Wherein, the photographing aid is electrically connected to the photographing device 300 by means of the data interface 220, such that users can save data in the photographing device 300 or charge the photographing device 300 anytime by means of the inner casing 200 in the photographing aid.

The above embodiments are merely illustrative or preferred ones of the invention, and neither the text description nor the drawings should be construed as limitations of the protection scope of the invention. Based on the concept as the invention, all equivalent structural transformations made according to the description and drawings, or direct/indirection applications to other related fields should fall within the protection scope of the invention.

What is claimed is:

1. A photographing aid, comprising:
an outer casing comprising a cavity and an opening in communication with the cavity, the opening being formed in an end of the outer casing to communicate the cavity with outside the outer casing;
an inner casing being detachably accommodated in the cavity via the opening, the inner casing comprising an interface configured to be electrically connected to a photographing device; and
a locking structure being arranged between the outer casing and the inner casing for releasably locking the inner casing in the outer casing.

2. The photographing aid according to claim 1, wherein the inner casing comprising at least one accommodation chamber;
at least one electronic device is accommodated in the at least one accommodation chamber; and
the at least one electronic device comprises a hard disk drive configured for storing data transferred from the photographing device or a battery for charging the photographing device.

3. The photographing aid according to claim 1, wherein the locking structure comprises a locking slot formed in an inner surface of a wall of the outer casing delimiting the cavity, and a locking member arranged on the inner casing for being interlocked in the locking slot.

4. The photographing aid according to claim 3, wherein the locking member comprises a press potion and a hook portion connected to the press portion, the press portion is elastically connected to the inner casing, and the hook portion is configured to be interlocked in the locking slot.

5. The photographing aid according to claim 4, wherein the outer casing defines a length direction and a height direction, the inner casing is mounted into the cavity in the length direction, and the press portion together with the hook portion is movable relative to the outer casing in the height direction.

6. The photographing aid according to claim 5, wherein the outer casing further comprises a notch; and
the locking member is received in the cavity and the press portion of the locking member extends through the notch to be exposed outside of the outer casing.

7. The photographing aid according to claim 6, wherein the wall of the outer casing comprises a pair of side walls and a pair of connecting walls cooperatively delimiting the cavity;
the connecting walls are located at opposite sides of the cavity in a width direction which is perpendicular to the length direction and the height direction;
the locking slot and the notch are defined in one of the side walls at interval; and
a guide strip is formed on an inner surface of each of the connecting walls.

8. The photographing aid according to claim 7, wherein each of the connecting wall comprises a middle portion and a pair of opposite end portions located at opposite side of the middle portion in the height direction, the middle portion is convex outwardly relative to the opposite end portions, and the guide strip is formed at the middle portion.

9. The photographing aid according to claim 7 wherein another one of the side walls is concaved inwardly in the height direction to form a recess at an outer surface thereof; and
a connecting member is received in the recess and secured to the another one of the side walls.

10. The photographing aid according to claim 9, wherein a mounting portion is arranged in a convex manner on a bottom of the recess;
the connecting member comprises a pair of positioning ribs spaced apart from each other and a receiving channel is formed between the pair of positioning ribs; and
the connecting member is secured on the mounting portion which is received in the receiving channel, and the positioning ribs are located at opposite sides of the mounting portion.

11. The photographing aid according to claim 1, wherein the locking member comprises a connecting component arranged on an inner surface of an end wall of the outer casing, and the inner casing is detachably connected to the connecting component.

12. The photographing aid according to claim 11, wherein the connecting component comprises a mounting shell and a clamping member mounted in the mounting shell;
the mounting shell is connected to the end wall of the outer casing;
the clamping member comprises a clamping end and a sliding end connected to the clamping end;
a barb is arranged in the inner casing;
the clamping end comprises at least two clamping arms for clamping the barb; and
the sliding end is slidably arranged within the mounting shell.

13. The photographing aid according to claim 12, wherein the mounting shell comprises a bottom and an opening opposite to the bottom, and the clamping member is mounted in the mounting shell via the opening;
the sliding end is elastically connected to the bottom of the mounting shell;
the connecting component further comprises a rocker arm;
a guide groove is formed in the mounting shell; and
the rocker arm comprises an end connected to the sliding end and an opposite end slidably connected to the guide groove.

14. The photographing aid according to claim 1, wherein at least one guide strip is arranged on an inner wall of the outer casing and slidably connected to the inner casing.

15. The photographing aid according to claim 1, wherein a connecting member is arranged on the outer casing and configured to be detachably connected to a handheld extension device on which the photographing device is fixed.

16. The photographing aid according to claim 15, wherein the connecting member is strip-shaped and parallelly arranged on an outer surface of the outer casing; or
the connecting member extends along a length direction of the outer casing, and a plurality of anti-skip structures extending along a width direction of the outer casing is arranged on the connecting member.

17. A photographing device, comprising a photographing device and a photographing aid according to claim 1, wherein the photographing aid is electrically connected to the photographing device by means of the data interface.

18. The photographing device according to claim 17, wherein a connecting member is arranged on the outer casing, the photographing device is fixed to a handheld extension device, and the connecting member is detachably connected to the handheld extension device.

19. The photographing device according to claim 18, wherein the photographing device comprises a pair of the photographing aids; and the handheld extension device comprises a pair of clamps configured to detachably catch the connecting members arranged on the bodies of the photographing aids.

20. The photographing device according to claim 18, wherein the connecting members are strip-shaped and positions where the clamps catch the connecting members are adjustable.
